(19) United States
(12) Patent Application Publication
(10) Pub. No.: US 2002/0153132 A1
(43) Pub. Date: Oct. 24, 2002

(54) Air conditioning system for automotive vehicles

(76) Inventor: Hideki Nagano, Saitama (JP)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 09/507,979

(22) Filed: Feb. 22, 2000

(30) Foreign Application Priority Data
Mar. 24, 1999 (JP) 11-78839

(51) Int. Cl. B60H 1/00

(52) U.S. Cl. 165/202

(57) ABSTRACT

There is provided an air conditioning system for an automotive vehicle, which is small-sized and excellent in temperature adjustability. An electric heater is arranged at a location downstream of a cooling heat exchanger in a manner blocking an air passage downstream of the cooling heat exchanger, for heating air which has passed through the cooling heat exchanger. The electric heater is divided into a plurality of separate heating areas. A unit casing houses the cooling heat exchanger and the electric heater and is formed with a plurality of outlet ports at respective locations downstream of the electric heater.

### BACKGROUND OF THE INVENTION

1. Field of the Invention

This invention relates to an air conditioning system for an automotive vehicle, and more particularly to an air conditioning system for use in a hybrid vehicle or an electric vehicle.

2. Description of the Prior Art

FIG. 5 is a conceptual representation of a conventional air conditioning system installed on an automotive vehicle.

The air conditioning system includes an evaporator 220, a heater core 230, an air-mixing door 235 and a casing 210.

The evaporator 220, the air-mixing door 235, and the heater core 230 are arranged in the casing 210 from the upstream side to the downstream side in the mentioned order.

The evaporator 220 is arranged at a location upstream of the air-mixing door 235 in a manner completely blocking a passage 211 within the casing 210, so that all air drawn into the casing 210 by a blower fan, not shown, passes through the evaporator 220.

The heater core 230 is arranged at a location downstream of the air-mixing door 235 in a manner blocking a lower half of the passage 211 within the casing 210.

The casing 210 is formed with a defroster air outlet port 240, a vent outlet port 250, and a foot outlet port 260.

Further, arranged in the casing 210 are a door 241 for opening/closing the defroster air outlet port 240, a door 251 for opening/closing the vent outlet port 250, and a door 261 for opening/closing the foot outlet port 260.

The defroster air outlet port 240 and the vent outlet port 250 are formed through the top of the casing 210, while the foot outlet port is formed through the bottom of the same.

A ratio between an amount of air passing through the evaporator 220 and an amount of air passing through the heater core 230 is determined according to a degree of opening of the air-mixing door 235, i.e. an angle of rotation of the same. The air cooled by the evaporator 220 and the air heated by the heater core 230 are mixed in an air-mixing chamber 236 and then blown into a compartment of the vehicle via the outlet ports 240, 250, and 260.

In the above conventional air conditioning system, however, the air-mixing door 235 and the air-mixing chamber 236 occupy a large portion of space within the casing 210, and this inevitably increases the size of the casing 210.

Further, a heating area of the heater core 230 and the amount of heat generated by the same cannot be adjusted. This makes it difficult to ensure adequate temperature adjustment in each operation mode of the air conditioning system.

### SUMMARY OF THE INVENTION

It is an object of the invention to provide an air conditioning system for an automotive vehicle, which is small-sized and excellent in temperature adjustability.

To attain the above object, according to a first aspect of the invention, there is provided an air conditioning system for an automotive vehicle, comprising:

a cooling heat exchanger;

an electric heater arranged at a location downstream of the cooling heat exchanger in a manner blocking an air passage downstream of the cooling heat exchanger, for heating air which has passed through the cooling heat exchanger, the electric heater being divided into a plurality of separate heating areas; and

a unit casing that houses the cooling heat exchanger and the electric heater, the unit casing being formed with a plurality of outlet ports at respective locations downstream of the electric heater.

According to this air conditioning system, it is possible to generate a desired amount of heat in a desired one or desired ones of the heating areas of the electric heater arranged in a manner blocking the air passage extending downstream from the cooling heat exchanger. Further, it is possible to dispense with an air-mixing door and an air-mixing chamber. Therefore, a desired heating capability of the system can be ensured, with enhanced temperature adjustability in every air-conditioning operation mode thereof. Further, the size of the unit casing can be reduced to thereby save the space occupied by the system.

Preferably, the separate heating areas are different in heating capability.

According to this preferred embodiment, it is possible to secure desired heating capability in respective operation modes of the air conditioning system by heating one or more desired heating areas alone.

Preferably, the unit casing is divided by a partition plate into a driver seat-side unit casing and an assistant driver seat-side unit casing, each of the driver seat-side unit casing and the assistant driver seat-side unit casing housing the electric heater.

According to this preferred embodiment, it is possible to set different temperatures respectively for the driver seat-side and the assistant driver seat-side of the automotive vehicle, whereby it is possible to easily ensure comfortableness both in a driver seat and an assistant driver seat in the compartment of the vehicle.

Preferably, the unit casing is formed with an opening via which the electric heater is inserted into the unit casing or removed therefrom.

According to this preferred embodiment, it is possible to insert or remove the electric heater without disassembling the unit casing, whereby the ease of operation of maintenance of the electric heater can be increased.

Preferably, the air conditioning system includes a plurality of doors for closing the outlet ports, respectively, and the doors are opened and closed independently of each other in a manner associated with operative states of the separate heating areas to thereby realize various air-conditioning modes.

To attain the above object, according to a second aspect of the invention, there is provided an air conditioning system for an automotive vehicle, comprising:

a cooling heat exchanger;

a plurality of electric heaters arranged at a location downstream of the cooling heat exchanger in a manner blocking an air passage downstream of the cooling heat exchanger, for heating air which has passed through the cooling heat exchanger; and

a unit casing that houses the cooling heat exchanger and the electric heaters, the unit casing being formed with a plurality of outlet ports at respective locations downstream of the electric heaters.

According this air conditioning system, it is possible to supply a desired amount of electric power to a desired one of the electric heaters arranged at a location downstream of the cooling heat exchanger in a manner blocking an air passage downstream of the cooling heat exchanger. Further, it is possible to dispense with an air-mixing door and an air-mixing chamber. Therefore, a desired heating capability of the system can be ensured, with enhanced temperature adjustability in every air-conditioning operation mode thereof. Further, the size of the unit casing can be reduced to thereby save the space occupied by the system.

Preferably, the electric heaters are different in heating capability.

According to this preferred embodiment, it is possible to secure desired heating capability in respective operation modes of the air conditioning system by supplying electric power to one or more desired electric heaters alone.

Preferably, the unit casing is divided by a partition plate into a driver seat-side unit casing and an assistant driver seat-side unit casing, each of the driver seat-side unit casing and the assistant driver seat-side unit casing housing the electric heaters.

According to this preferred embodiment, it is possible to set different temperatures respectively for the driver seat-side and the assistant driver seat-side of the automotive vehicle, whereby it is possible to easily ensure comfortableness both in a driver seat and an assistant driver seat in the compartment of the vehicle.

Preferably, the unit casing is formed with an opening via which the electric heaters are inserted into the unit casing or removed therefrom.

According to this preferred embodiment, it is possible to insert or remove the electric heaters without disassembling the unit casing, whereby the ease of operation of maintenance of the electric heaters can be increased.

Preferably, the air conditioning system includes a plurality of doors for opening and closing the outlet ports, respectively, and the plurality of doors are opened and closed independently of each other in a manner associated with operative states of the electric heaters to thereby realize various air-conditioning modes.

The above and other objects, features and advantages of the present invention will become more apparent from the following detailed description taken in conjunction with accompanying drawings.

### BRIEF DESCRIPTION OF THE DRAWINGS

FIG. 1 is a conceptual representation of an air conditioning system for an automotive vehicle, according to a first embodiment of the invention;

FIGS. 2A to 2E are schematic explanatory views which are useful in explaining operations of the FIG. 1 air conditioning system in respective operation modes thereof;

FIG. 3 is a conceptual representation of an air conditioning system for an automotive vehicle, according to a second embodiment of the invention;

FIG. 4 is a conceptual representation of an air conditioning system for an automotive vehicle, according to a third embodiment of the invention; and

FIG. 5 is a conceptual representation of a conventional air conditioning system for an automotive vehicle.

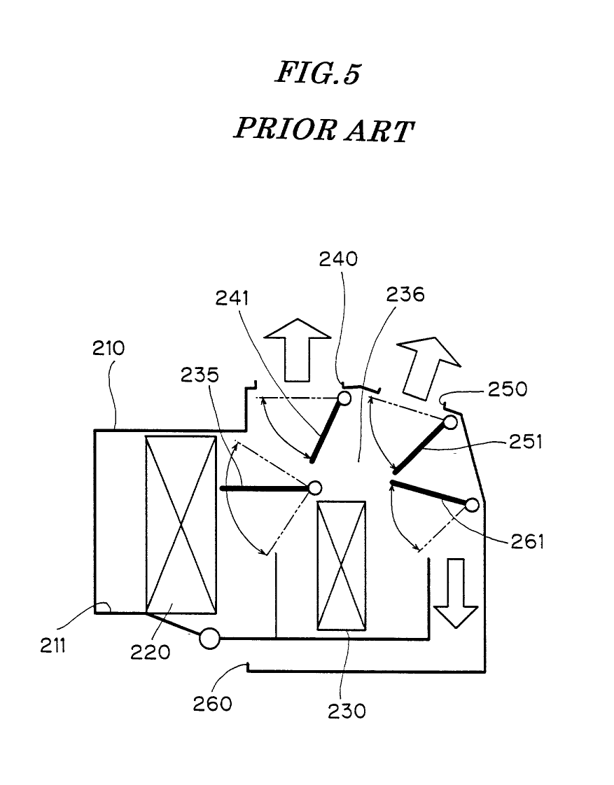

### DETAILED DESCRIPTION OF THE PREFERRED EMBODIMENTS

The invention will now be described in detail with reference to the drawings showing preferred embodiments thereof.

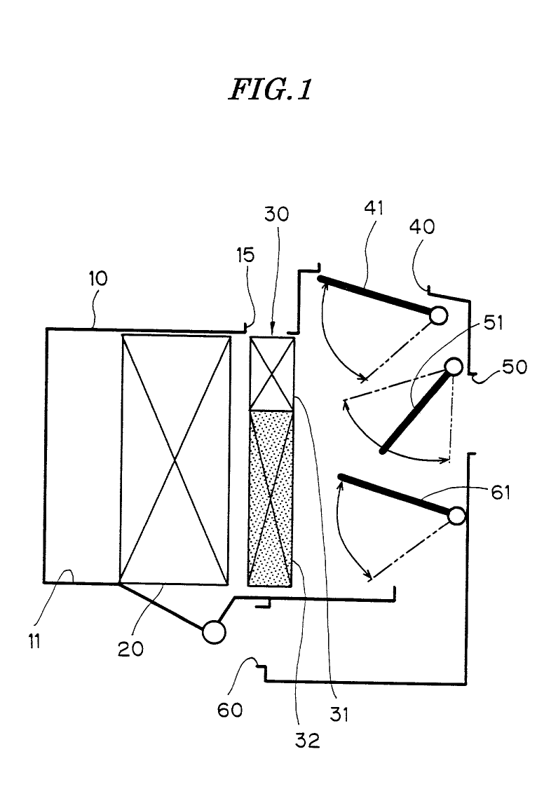

FIG. 1 is a conceptual representation of an air conditioning system installed on an automotive vehicle, according to a first embodiment of the invention.

The air conditioning system has a casing (unit casing) 10 in which an evaporator (cooling heat exchanger) 20 and an electric heater 30 are arranged from the upstream side to the downstream side in the mentioned order.

The evaporator 20 is a heat exchanger for cooling air sent by an air blower unit, not shown, attached to the casing 10. The evaporator 20 is arranged within the casing 10 in a manner blocking all transverse cross-sectional area of a passage (air passage) 11 within the casing 10. All air introduced into the casing 10 passes through the evaporator 20.

The electric heater 30 is also arranged within the casing 10 in a manner blocking all transverse cross-sectional area of the passage (air passage) 11 within the casing 10, and all air introduced into the casing 10 passes through the electric heater 30.

The electric heater 30 has two separate heating areas 31 and 32 which are different in size from each other. The heating areas 31 and 32 are each connected to a battery, not shown, via a switching device, not shown, for controlling supply of electric power. The capacity of the battery is approximately 260 amp-hr.

Further, the casing 10 is formed with an opening 15 via which the electric heater 30 is inserting into the casing 10 or removed from the same.

A defroster air outlet port 40, a vent outlet port 50, and a foot outlet port 60 are each formed at respective downstream end portions of the casing 10.

The air in the casing 10 is delivered from each of the outlet ports 40, 50, and 60 into a compartment of the vehicle via a corresponding duct, not shown.

The outlet ports 40, 50, and 60 are opened and closed by three doors 41, 51, and 61, respectively.

The doors 41, 51, and 61 are opened or closed independently of each other depending on the operation mode of the air conditioning system. The opening and closing of the doors 41, 51, and 61 as well as the operation of the switching device for supplying electric power to the heating areas 31 and 32 are controlled by a stored program control method e.g. by the use of a one-chip microcomputer, not shown.

Next, the operation of the air conditioning system constructed as above will be described.

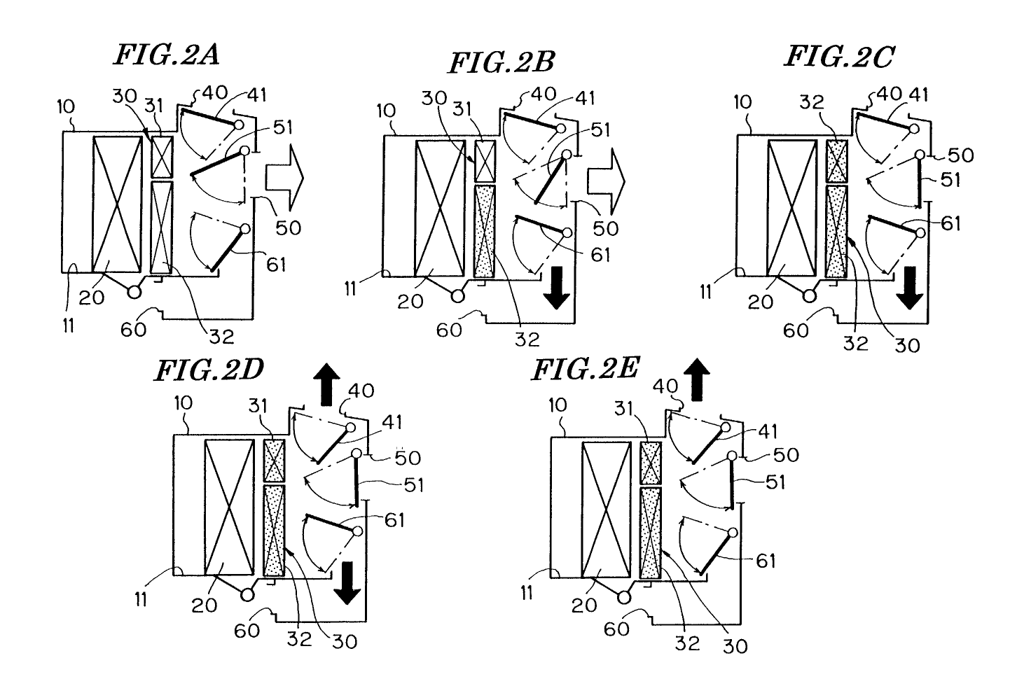

FIGS. 2A to 2E are schematic explanatory views which are useful in explaining operations of the air conditioning system in respective operation modes thereof.

In the electric heater 30 appearing in the figures, each stippled heating area represents an energized state, while each blank heating area represents a non-energized state.

When a vent mode is selected, the heating areas 31 and 32 are both non-energized.

At the same time, the doors 41, 51, and 61 are driven such that the doors 41 and 61 are closed, and the door 51 is opened (see FIG. 2A).

Air introduced into the passage 11 is cooled while passing through the evaporator 20, and then passes through the electric heater 30. In this case, the air is not heated by the electric heater 30, and hence cold air is blown into the compartment of the vehicle via the vent outlet port 50.

When a bi-level mode is selected, the heating area 31 is non-energized, whereas the heating area 32 is energized. Accordingly, only the heating area 32 is heated.

At the same time, the doors 41, 51, and 61 are driven such that the door 41 is closed, the door 61 is opened, and the door 51 is half opened (see FIG. 2B).

Air introduced into the passage 11 is cooled while passing through the evaporator 20, and then passes through the electric heater 30. In this case, cold air flows downstream from the heating area 31, while heated air flows downstream from the heating area 32. As a result, the cold air is blown out via the vent outlet port 50, and the heated air via the foot outlet port 60.

In the case of the bi-level mode being selected, the degree of opening of the door 51 and the amount of electric power supplied to the heating area 32 are adjusted such that temperature difference between the cold air blown out via the vent outlet port 50 and the heated air blown out via the foot outlet port 60 is held within a range of 15 to 25° C.

When a foot mode is selected, the heating areas 31 and 32 are both energized and heated. At the same time, the doors 41, 51, and 61 are driven such that the doors 41 and 51 are closed, and the door 61 is opened (see FIG. 2C).

Air introduced into the passage 11 is cooled while passing through the evaporator 20, and then passes through the electric heater 30. In this case, heated air flows downstream from both of the heating area 31 and the heating area 32 and blown out via the foot outlet port 60.

When a defroster/foot mode is selected, the heating areas 31 and 32 are both energized and heated.

At the same time, the doors 41, 51, and 61 are driven such that the doors 41 and 61 are opened, and the door 51 is closed (see FIG. 2D).

Air introduced into the passage 11 is cooled while passing through the evaporator 20, and then passes through the electric heater 30. In this case, heated air flows downstream from both of the heating area 31 and the heating area 32 and blown out via the defroster air outlet port 40 and the foot outlet port 60.

In the case of the defroster/foot mode being selected, the degree of opening of the door 41 and the degree of opening of the door 61 as well as the amount of electric power supplied to the heating area 31 and the amount of electric power supplied to the heating area 32 are adjusted such that temperature difference between the heated air blown out via the defroster air outlet port 40 and the heated air blown out via the foot outlet port 60 is held within a range 0 to 10C.

When a defroster mode is selected, the heating areas 31 and 32 are both energized and heated.

At the same time, the doors 41, 51, and 61 are driven such that the doors 41 is opened, and the doors 51 and 61 are closed (see FIG. 2E).

Air introduced into the passage 11 is cooled while passing through the evaporator 20, and then passes through the electric heater 30. In this case, heated air flows downstream from both of the heating area 31 and the heating area 32 and blown out via the defroster air outlet port 40.

The above embodiment provides the following effects:

Firstly, since the electric heater 30 which is capable of generating a desired amount of heat in each of the heating areas 31 and 32 thereof is arranged at the location downstream of the evaporator 20, it is possible to secure desired heating capability as well as to enhance temperature adjustability in each operation mode.

Secondly, since an air-mixing door and an airmixing chamber are dispensed with, the size of the casing 10 can be reduced to save space occupied by the system, and space within the compartment of the vehicle can be increased.

Thirdly, it is possible to insert the electric heater 30 into or remove the same from the casing 10 via the opening 15 without removing the blower unit, which increases ease of operation of maintenance of the electric heater 30.

Further, although the electric heater 30 is divided into the two separate heating areas in the above embodiment, this is not limitative, but it may be divided into more than two separate heating areas. According to this variation, it is possible to effect more delicate temperature adjustment.

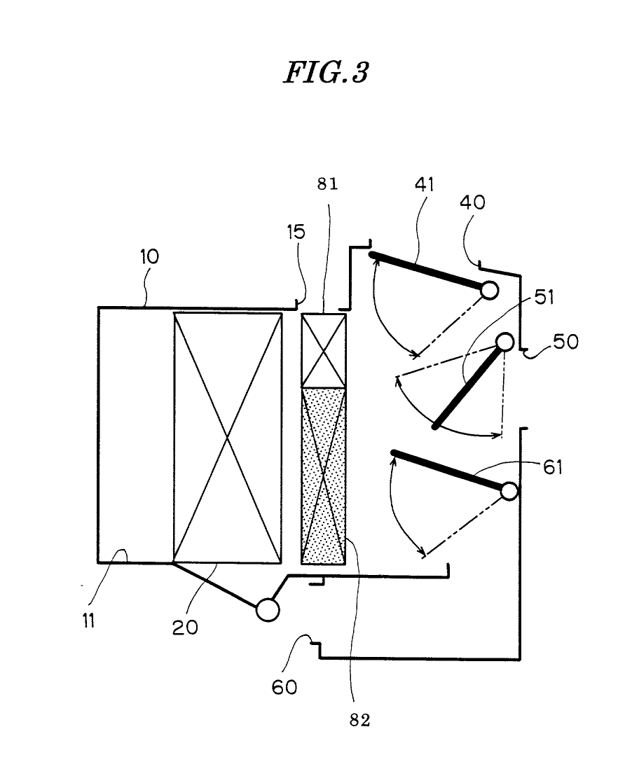

FIG. 3 is a conceptual representation of an air conditioning system installed on an automotive vehicle, according to a second embodiment of the invention. Component parts and elements similar to those of the first embodiment are designated by identical reference numerals, and detailed description thereof is omitted.

The present embodiment is distinguished from the first embodiment in which the electric heater 30 is divided into the two separate heating areas in that there are used two electric heaters 81 and 82 instead of diving a single electric heater into two separate areas.

According to the second embodiment, similarly to the first embodiment, it is possible to supply a desired amount of electric power to a desired one of the electric heaters arranged at a location downstream of the cooling heat exchanger in a manner blocking an air passage downstream of the cooling heat exchanger. Further, it is possible to dispense with an air-mixing door and an air-mixing chamber.

Although in the second embodiment, the two electric heaters 81 and 82 are employed, this is not limitative, there may be used more than two electric heaters. According to this variation, it is possible to effect more delicate temperature adjustment.

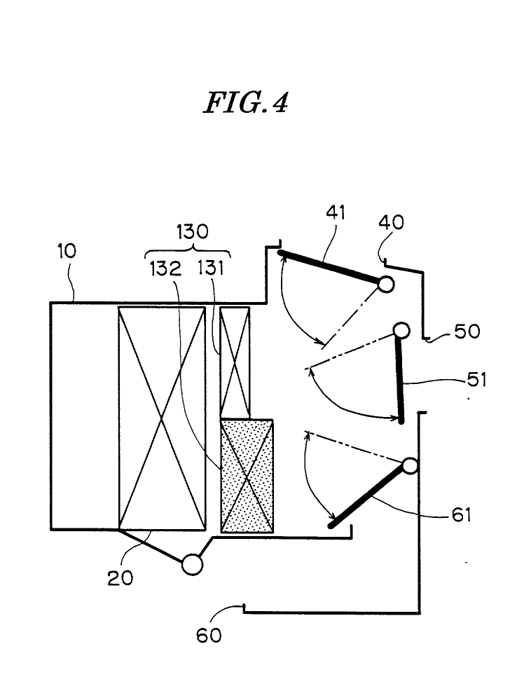

FIG. 4 is a conceptual representation of an air conditioning system installed on an automotive vehicle, according to a third embodiment of the invention. Component parts and elements similar to those of the first embodiment are designated by identical reference numerals, and detailed description thereof is omitted.

The present embodiment is distinguished from the first embodiment in that an electric heater 130 is divided into two separate heating areas 131 and 132 which are identical to each other in size but different from each other in heat capacity, and hence different in heating capability.

The third embodiment provides the same effects as obtained by the first embodiment.

In the above embodiments, the casing 10 may be divided by a partition plate, not shown, into a driver seat-side unit casing and an assistant driver seat-side unit casing, and an electric heater may be provided in each of them.

This construction makes it possible to easily ensure comfortableness both in a driver seat and an assistant driver seat in the compartment of a vehicle.

Further, a single-structure electric heater may be used. In this case, the air conditioning system may be configured such that a bypass passage for cold air bypassing the electric heater and a door for controlling the amount of the cold air passing through the bypass passage are provided, and the operation of the door is controlled in combination the operations of the doors 41, 51, and 61.

It is further understood by those skilled in the art that the foregoing are preferred embodiments of the invention, and that various changes and modification may be made without departing from the spirit and scope thereof.

What is claimed is:

1. An air conditioning system for an automotive vehicle, comprising:
a cooling heat exchanger;
an electric heater arranged at a location downstream of said cooling heat exchanger in a manner blocking an air passage downstream of said cooling heat exchanger, for heating air which has passed through said cooling heat exchanger, said electric heater being divided into a plurality of separate heating areas; and
a unit casing that houses said cooling heat exchanger and said electric heater, said unit casing being formed with a plurality of outlet ports at respective locations downstream of said electric heater.

2. An air conditioning system according to claim 1, wherein said separate heating areas are different in heating capability.

3. An air conditioning system according to claim 1, wherein said unit casing is divided by a partition plate into a driver seat-side unit casing and an assistant driver seat-side unit casing, each of said driver seat-side unit casing and said assistant driver seat-side unit casing housing said electric heater.

4. An air conditioning system according to claim 1, wherein said unit casing is formed with an opening via which said electric heater is inserted into said unit casing or removed therefrom.

5. An air conditioning system according to claim 1, including a plurality of doors for opening and closing said outlet ports, respectively, wherein said doors are opened and closed independently of each other in a manner associated with operative states of said separate heating areas to thereby realize various airconditioning modes.

6. An air conditioning system for an automotive vehicle, comprising:
a cooling heat exchanger;
a plurality of electric heaters arranged at a location downstream of said cooling heat exchanger in a manner blocking an air passage downstream of said cooling heat exchanger, for heating air which has passed through said cooling heat exchanger; and
a unit casing that houses said cooling heat exchanger and said electric heaters, said unit casing being formed with a plurality of outlet ports at locations downstream of said electric heaters.

7. An air conditioning system according to claim 6, wherein said electric heaters are different in heating capability.

8. An air conditioning system according to claim 6, wherein said unit casing is divided by a partition plate into a driver seat-side unit casing and an assistant driver seat-side unit casing, each of said driver seat-side unit casing and said assistant driver seat-side unit casing housing said electric heaters.

9. An air conditioning system according to claim 6, wherein said unit casing is formed with an opening via which said electric heaters are inserted into said unit casing or removed therefrom.

10. An air conditioning system according to claim 6, including a plurality of doors for closing said plurality of outlet ports, respectively, wherein said doors are opened and closed independently of each other in a manner associated with operative states of said electric heaters to thereby realize various airconditioning modes.
